(19) United States
(12) Patent Application Publication
(10) Pub. No.: US 2001/0000937 A1
(43) Pub. Date: May 10, 2001

(54) Unitary composite article and method of making same

(75) Inventors: Larry J. Winget, Leonard, MI (US); Darius J. Preisler, Macomb, MI (US)

Correspondence Address: Lawrence G. Almeda, Brooks & Kushman P.C., 1000 Town Center, Twenty-Second Floor, Southfield, MI, 48075, US

(73) Assignee: Patent Holding Company, Fraser, MI (US)

(21) Appl. No.: 09/732,697

(22) Filed: Dec. 8, 2000

Related U.S. Application Data
(63) Continuation-in-part of application No. 09/098,212, filed on Jun. 16, 1998.
Application No. 09/098,212 is a continuation-in-part of application No. 08/606,584, filed on Feb. 26, 1996, now Pat. No. 5,765,864.

(51) Int. Cl. B60R 21/20; B29D 22/04

(52) U.S. Cl. 280/731; 264/572; 264/269

(57) ABSTRACT

The present invention involves a unitary composite article and method of making same. The unitary composite article comprises a one-piece, plastic body and a stiffening material. The one-piece plastic body includes a collapsible first portion having an inner cavity defined by an outer wall formed by an injection molding process. The plastic of the outer wall has a thickness which makes the outer wall susceptible to collapse into the inner cavity during normal usage of the article. The stiffening material substantially fills the inner cavity by an injection process. The stiffening material provides rigidity to the article to prevent collapse of the outer wall into the inner cavity when the plastic body experiences substantial external forces at the first portion during normal usage.

### CROSS REFERENCE TO RELATED APPLICATIONS AND PATENTS

1. This application is a continuation in part application of U.S. patent application entitled “UNITARY COMPOSITE PLASTIC STEERING WHEEL AND AIRBAG ASSEMBLY,” having U.S. Ser. No. 09/098,212, filed Jun. 16, 1998, which is a continuation in part application of U.S. patent application entitled “UNITARY COMPOSITE PLASTIC STEERING WHEEL AND AIRBAG COVER ASSEMBLY AND METHOD OF MAKING SAME,” having Ser. No. 08/606,584, filed Feb. 26, 1996, now U.S. Pat. No. 5,765,864. The application is related to a U.S. Patent entitled “MOLD FOR USE IN A GAS-ASSISTED INJECTION MOLDING SYSTEM AND GAS PIN ASSEMBLY FOR USE THEREIN,” and having U.S. Pat. No. 6,120,275.

### TECHNICAL FIELD

2. This invention relates to unitary composite articles having one-piece bodies and stiffening material which substantially fills the bodies and a method of making same.

### BACKGROUND ART

3. Today, plastics are used to make portions of vehicular workpieces and assemblies, such as steering wheels, many of which also include metal to provide rigidity and support thereto. As the demand for high quality workpieces increases, the demand for cost effective methods and systems for manufacture also increases. Many typical multi-piece workpieces have been manufactured as one-piece workpieces, feeding the demand for higher quality workpieces. Many one-piece workpieces and assemblies, such as steering wheels, typically have an inner metal core or frame structure to support an outer plastic layer. However, workpieces such as steering wheels are costly and difficult to make.

4. Moreover, advances in technology have allowed manufacturers to more easily manufacture unitary composite articles or workpieces having inner plastic cores or frame structures. However, manufacturers are challenged in improving the process of filling a unitary workpiece with plastic to form a more rigid or more stiff frame structure therein. In addition, manufacturers having pre-formed hollow workpieces which have been found to need more rigidity or stiffness have experienced difficulty in making such workpieces more rigid or more stiff in an efficient and cost effective way. Misalignments of a workpiece and a fixture to which the workpiece is disposed may cause molten plastic overfilling. This leads to time consuming cleanups and loss of production. In only proper alignment of the workpiece to the fixture can molten plastic overfills be avoided.

5. Additionally, designers of vehicular assemblies, such as airbag assemblies, are challenged in developing safe and aesthetically pleasing products. Supplemental occupant restraint systems for motor vehicles, i.e., airbags, typically require covers which allow an airbag to exit the airbag cover when deployed. One type of airbag cover includes a front panel which has a predetermined tear seam design formed therein to allow the airbag to exit the airbag cover when deployed. Not only must the airbag cover perform the utilitarian function of breaking apart along its predetermined tier seam design, but it should also match the vehicle interior decor and trim materials such as the instrument panel, seats, door panels, steering wheel and posts. Also, not only must the airbag cover allow the airbag to exit the airbag cover when deployed, but also the airbag cover must stay together to the extent that it does not break apart so as to present projectile(s).

### DISCLOSURE OF INVENTION

6. It is an object of the present invention to provide a unitary composite article comprising a one-piece, plastic body and a stiffening material. The one-piece, plastic body includes a collapsible first portion having an inner cavity defined by an outer wall formed by an injection molding process. The plastic of the outer wall has a thickness which makes the outer wall susceptible to collapse into the inner cavity during normal usage of the body. The stiffening material substantially fills the inner cavity by an injection process. The stiffening material provides rigidity to prevent collapse of the outer wall into the cavity when the plastic body experiences substantial external forces at the first portion during normal usage.

7. It is another object of the present invention to provide a method of making a unitary composite article. The method includes providing a one-piece plastic body including a collapsible first portion having an inner cavity defined by an outer wall formed by an injection molding process. The body has a first hole in fluid communication with the inner cavity. The plastic of the outer wall has a thickness which makes the outer wall susceptible to collapse into the inner cavity during normal use of the body. The method further includes injecting a flowable stiffening material through the first hole and into the plastic body until the stiffening material substantially fills the inner cavity to define the unitary composite article.

8. It is another object of the present invention to provide a unitary composite steering wheel and airbag cover assembly which is relatively easy to make and which includes a one-piece soft plastic body including a circular first rim portion which encloses a circular second rim portion of a more rigid plastic, skeletal frame structure, thereby eliminating the need for a metal frame structure.

9. Another object of the present invention is to provide a unitary composite steering wheel and airbag cover assembly wherein an airbag cover portion sufficiently matches a rim of the assembly in color and other physical characteristics yet eliminates the need for a more costly metal, skeletal frame structure. The frame further includes a central support portion having a central aperture aligned with the air bag cover portion and is adapted to be connected to the air bag system about the central aperture in order to allow an air bag of the air bag system to exit the air bag cover portion when deployed. The central support portion is configured in plastic which is sufficiently more rigid than the first rim portion to support the skeletal frame structure as the air bag exits the air bag cover portion when deployed through the central aperture.

10. In carrying out the above objects and other objects of the present invention, the unitary composite steering and airbag cover assembly is provided. The assembly cover includes a one-piece, plastic body including a circular first rim portion having a perimeter and an air bag cover portion with a predetermined tear seam design formed therein. The airbag cover portion is adapted to overlie an inflatable airbag system. The assembly also includes a one-piece plastic skeletal frame structure including a circular second rim portion enclosed within the first rim portion. The frame structure has an aperture aligned with the airbag cover portion to allow an airbag of the airbag system to exit the airbag cover portion when deployed. Preferably, the plastic of the frame structure is more rigid than the plastic of the body and the plastic of the body is softer than the plastic of the frame structure. The plastic of the frame structure may be glass-filled nylon whereas the plastic of the body may be TPO, TPU, DYM or Santoprene. The two different plastics may be co-injected or the plastic of the body may be utilized in a gas-assisted injection molding process to hollow out the body and then the more rigid plastic of the frame structure can be injected into the hollowed-out body.

11. The above objects and other objects, features, and advantages of the present invention are readily apparent from the following detailed description of the best mode for carrying out the invention when taken in connection with the accompanying drawings.

### BRIEF DESCRIPTION OF DRAWINGS

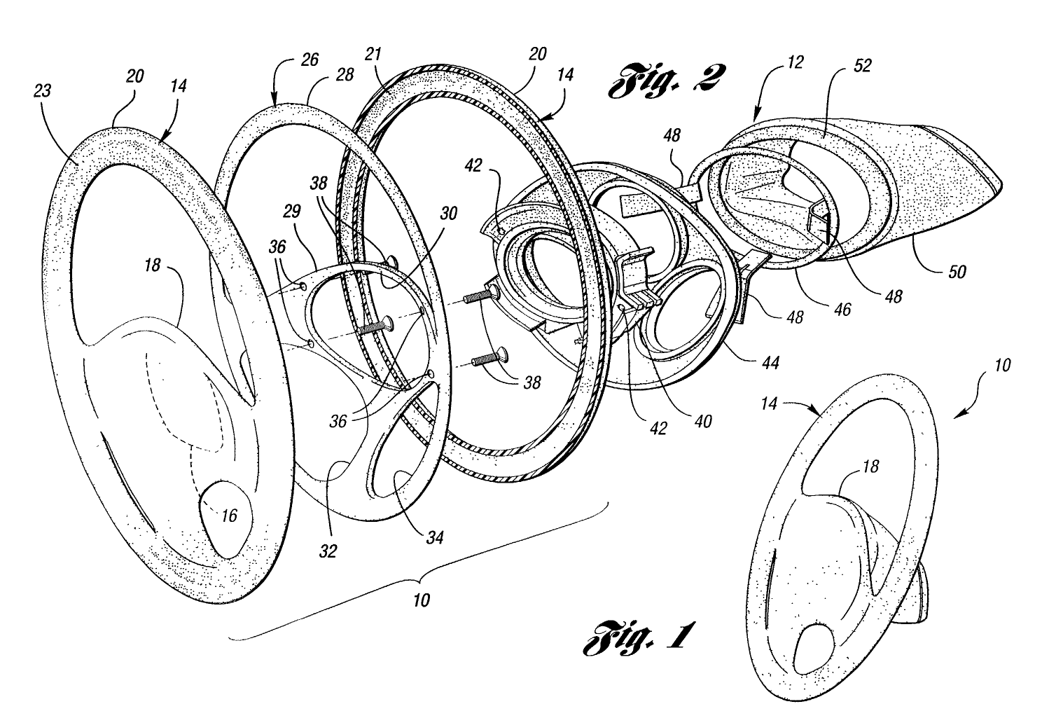

12. FIG. 1 is a perspective view showing a unitary composite assembly steering wheel and air bag cover assembly constructed in accordance with the present invention;

13. FIG. 2 is an exploded view of the assembly with the front and rear sections of a circular first rim portion separated from each other to show a circular second rim portion, together with other parts including mounting parts of an air bag system adapted to be mounted at an end of a steering wheel post;

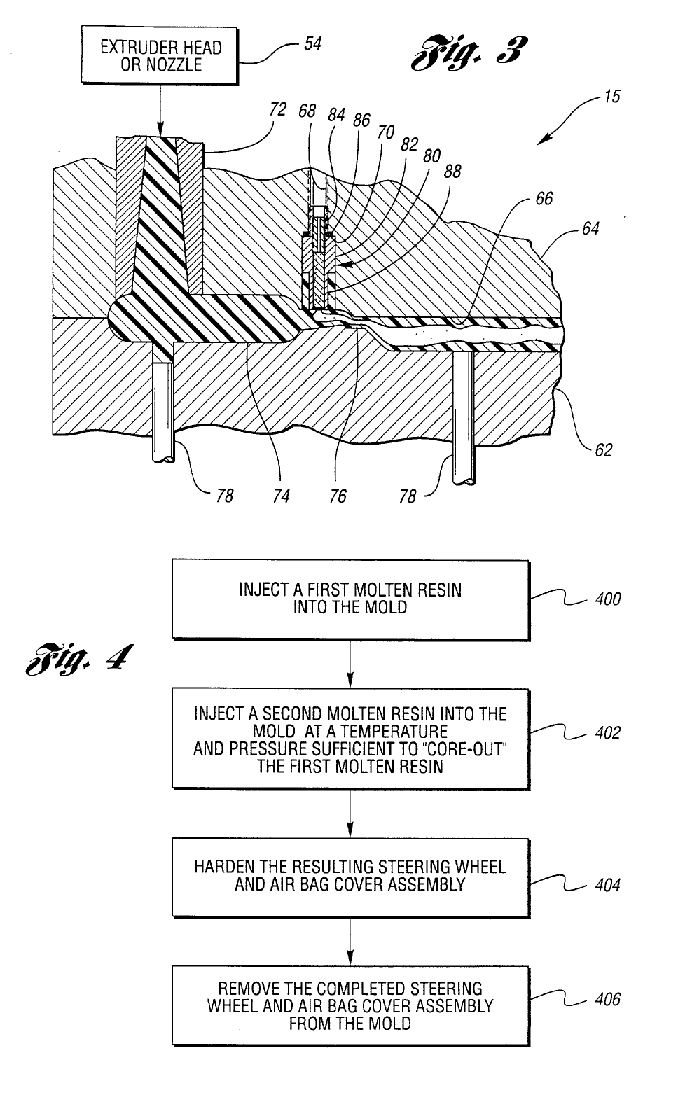

14. FIG. 3 is a view, partially broken away and in cross-section of an injection molding system which may be utilized to make the assembly of the present invention;

15. FIG. 4 is a block diagram flow chart illustrating the various method steps taken to practice a first method to make the assembly;

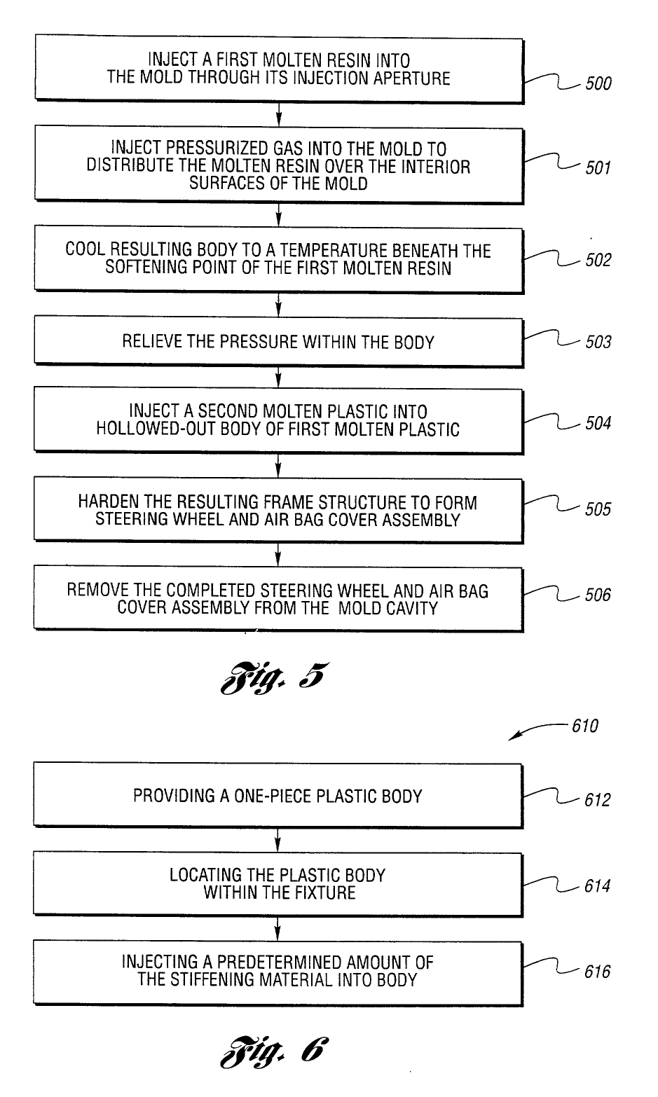

16. FIG. 5 is a block diagram flow chart of a second method to make the assembly;

17. FIG. 6 is a block diagram flow chart illustrating steps taken in filling stiffening material into a workpiece such as the steering wheel of FIGS. 1-3;

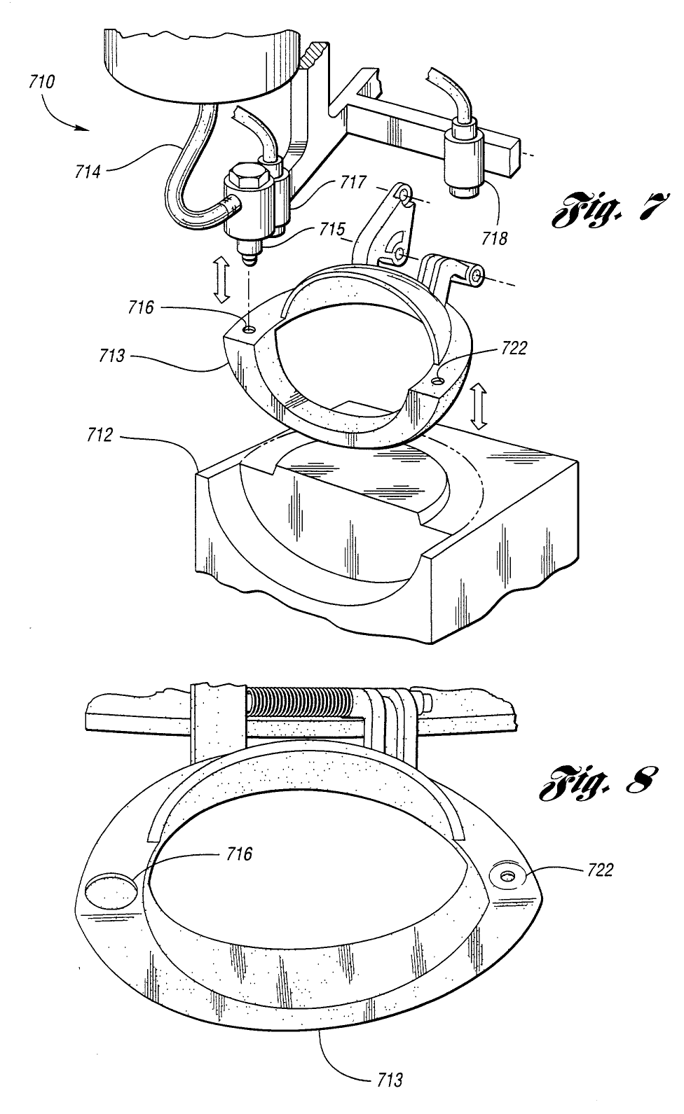

18. FIG. 7 is a perspective view of a system implementing the methods of FIG. 6 in accordance with the present invention; and

19. FIG. 8 is a perspective view of a pre-formed hollow workpiece into which the system of FIG. 7 may inject stiffening material.

### BEST MODE FOR CARRYING OUT THE INVENTION

20. Generally, the present invention provides an improved method of making a unitary composite article. In making the unitary composite article, stiffening material is injected into hollow bodies of workpieces requiring more stiffness. The present invention provides a cost effective way of injecting a flowable stiffening material or more rigid material into hollow workpieces while minimizing overfills and underfills of the material. The improved method produces a unitary composite article having a one-piece, plastic body filled with stiffening or more rigid material. As will be shown in greater detail below in one example of the present invention, the one-piece, plastic body includes a collapsible first portion having an inner cavity defined by an outer wall formed by an injection molding process. As shown below, the plastic of the outer wall has a thickness susceptible to collapse into the inner cavity during normal usage of the article.

21. The stiffening material substantially fills the inner cavity by an injection molding process. As shown below, the stiffening material provides greater stiffness or rigidity to the article and prevents the collapse of the outer wall into the inner cavity when the one-piece, plastic body experiences substantially external forces at the first portion during normal usage.

22. Referring now to the drawing figures, there is illustrated in FIG. 1 a perspective view showing an embodiment of a unitary composite article. The unitary composite article is exemplified by a steering wheel and air bag cover assembly, generally indicated at 10, constructed in accordance with the present invention. The assembly 10 preferably is installed over an inflatable air bag system, a support structure of which is generally shown at 12 in FIG. 2, mounted at the end of a steering wheel post (not shown). The occupant restraint air bag system is typically mounted at the interior end of the steering wheel post adjacent the assembly 10 so that the air bag may deploy between the vehicle driver and the steering wheel post to prevent injury during an accident or other period of sudden deceleration.

23. Referring specifically now to FIG. 2, there is illustrated in detail an embodiment of the assembly 10 constructed in accordance with the present invention. The assembly 10 includes a one-piece injection molded plastic body, generally indicated at 14, which is preferably injection molded in a mold 15 (FIG. 3) and has a predetermined tear seam design as indicated at 16 formed in an air bag cover portion 18. The air bag cover portion 18 is adapted to overlie an inflatable air bag system. The plastic body 14 also includes a first portion or a circular first rim portion 20. The first rim portion 20 has been separated into front and rear sections and from a second portion or a second rim portion 28 of a stiffening material or a plastic skeletal frame structure, generally indicated at 26, to illustrate the 30 second rim portion 28. The first rim portion 20 is a collapsible portion which has an inner cavity 21 defined by an outer wall 23 which is formed by an injection molding process. The plastic of the outer wall has a thickness which is susceptible to collapse into the inner cavity during normal usage of the body. However, it is to be understood that the two sections of the first rim portion are integrally formed with the second rim portion 28 within the mold 15. The second plastic of the frame structure 26 is compatible with the plastic of the body 14 so that the second rim portion 28 of the frame structure 26 bonds with the first rim portion 20 of the body 14 by diffusion between the immediately adjacent surfaces thereof in the mold 15 to prevent the body 14 from separating from the frame structure 26 during use of the assembly 10. The second portion 28 substantially fills the inner cavity by an injection molding process. The second portion 28 is configured in a material to provide stiffness or rigidity to the steering wheel and prevent collapse of the outer walls into the inner cavity. In this embodiment, the article is produced by a gas-assisted injection molding process. As shown in FIGS. 1 and 2, the unitary composite steering wheel has walls which are elongated to form the plastic body 14.

24. As previously mentioned, the frame structure 26 is made from a second plastic also injection molded in the mold 15. In this embodiment, the second plastic or stiffening material may be more rigid and not as soft as the plastic of the plastic body 14. Preferably, the plastic of the body 14 is a thermoplastic such as TPO, TPU, DYM, santoprene, etc., whereas the stiffening material may be more rigid but not as soft plastic such as glass-filled nylon, high density polymer, and epoxy. However, it is to be noted that the stiffening material may be the same or softer material than the plastic body, but compacted more densely therein to provide greater stiffness.

25. The frame structure 26 also includes a central support portion 29 having a plurality of apertures 30, 32 and 34 formed therethrough. One aperture 30 is aligned with the cover portion 18. An air bag of the air bag system exits through the aperture 30 and through the cover portion 18 when deployed.

26. The support portion 29 preferably has a plurality of holes 36 formed about the aperture 30 to receive and retain a like plurality of fasteners 38. The fasteners 38 secure a steel inflator assembly collar 40 of the support structure 12 to the frame structure 26 at holes 42.

27. Typically, if the plastic of the body 14 is a thermoplastic, the durometer of the body 14 will be in the range of about 37 Shore D to 52 Shore D, while the flexural modulus will be in the range of about 30,000 to 70,000 psi. If a RIM plastic is used, the modulus could be lower.

28. The support structure 12 also typically includes a plastic trim plate 44, a metal mounting rim 46 with attachment flanges 48 and a steering column cowl 50 having a close-out seal 52.

29. Referring now to FIG. 3, there is illustrated the mold 15 and an extruder head or nozzle 54 of an injection molding system for making the unitary composite steering wheel and air bag cover assembly 10 of the present invention. However, it is to be understood that other methods and systems may be utilized to make a unitary composite steering wheel and air bag cover assembly 10 of the prevent invention.

30. The mold 15 includes a first mold half 62 and a second mold half 64. The first and second mold halves 62 and 64, respectively, are movable relative to each other between an open position and a closed position, wherein the first and second mold halves 62 and 64, respectively, define an article-defining cavity 66.

31. The second mold half 64 includes a gas passageway 68 which extends from an exterior surface (not shown) of the second mold half 64 to an inner interior surface 70 of the second mold half 64 in fluid communication with the article-defining cavity 66.

32. The second or stationary mold half 64 includes a sprue 72 for communicating thermoplastic material to a runner 74 which, in turn, communicates with the article-defining cavity 66 via a gate 76. A thermoplastic flow path is defined by the sprue 72, the runner 74 and the gate 76. Article ejector pins 78 can extend through the first or movable mold half 62 to eject a completed part.

33. As previously mentioned, the injection molding system includes an extruder or nozzle 54 for injecting predetermined amounts or shots of first and second types of molten resin into the mold 15. The nozzle 54 may be generally of the type disclosed in U.S. Pat. No. 5,047,183 which is capable of co-injecting two types of plastics as well as pressurized gas into the mold 15.

34. Instead of injecting pressurized gas from the nozzle 54, the system 56 may include a gas pin assembly, generally indicated at 80, for injecting the pressurized gas. The gas pin assembly 80 includes a one-piece housing, generally indicated at 82. As shown in FIG. 3, a base portion 84 of the housing 82 is threadedly secured to the second mold half 64 at the interior surface 70 of the second mold half 64 so that the gas pin assembly 80 can be readily removed from the second mold half 64 in the open position of the mold 15. A rubber O-ring 86 is provided about the base portion 84 to seal the housing 82 within the second mold half 64.

35. The housing 82 also includes a hexagonal head portion 88 so that the assembly 80 can be readily removed from the second mold half 64 in the open position of the mold 15 by a conventional tool (not shown). Details of the assembly 80 can be found in the above-noted application entitled “Mold For Use In A Gas-Assisted Injection Molding System And Gas Pin Assembly For Use Therein”.

36. Referring now to FIG. 4, there is illustrated the various process steps of a co-injection method for forming the assembly 10 with further reference to FIG. 3. This method does not need nor require the gas pin assembly 80.

37. At block 400, initially the first molten plastic is injected into the mold cavity 66 of the mold 15 through its injection nozzle 54. At block 402, before the first plastic has solidified, the second molten plastic is injected into the mold 15 through the nozzle 54 at a temperature and pressure sufficient to “core-out” or hollow out the first plastic. At block 404, the resulting steering wheel and air bag cover assembly 10 is cooled to a temperature beneath the softening point of both plastics. Finally, at block 406, the completed steering wheel and air bag cover assembly 10 is removed from the mold 15.

38. Referring now to FIG. 5, there is disclosed in block diagram flow chart form a gas-assist method for forming the unitary composite steering wheel and air bag cover assembly 10 of the present invention. This method utilizes the gas pin assembly 80 unless the nozzle 54 also has the capability of injecting pressurized gas into the mold 15 as illustrated in U.S. Pat. No. 5,047,183.

39. At block 500, the first molten resin is injected into the mold 15 through its injection aperture. At block 501, pressurized gas is inserted into the mold 15 to distribute the molten resin over the interior surfaces 66 of the mold 15. At block 502, the resulting body 14 is cooled to a temperature beneath the softening point of the first molten resin. At block 503, the pressure within the curved first rim portion 20 of the body 14 is relieved. At block 504, a second molten plastic is injected from the nozzle 54 into the hollowed-out first rim portion 20. At block 505, the resulting steering wheel and air bag cover assembly 10 is cooled to a temperature beneath the softening point of both resins. Finally, at block 506, the mold 15 is open and the completed steering wheel and air bag cover assembly 10 is removed from the mold 15.

40. In this way, the assembly 10 is formed with the second rim portion 28 of the skeletal frame structure 26 within the first rim portion 20 of a one-piece body 14 and an integral air bag cover portion 18 with a predetermined tear seam design 16 formed therein in a single mold cavity. The air bag cover portion 18 with the predetermined tear seam design 16 and the aligned aperture 30 allow an air bag to exit the cover portion 18 when deployed.

41. It is to be noted that determinations are conducted during operation of the methods provided above. As previously stated, manufacturers have experienced difficulty in filling a hollow body or workpiece with stiffening material to form a frame structure therein. Manufacturers have also found that many pre-formed workpieces of manufacture need more rigidity to their bodies or exterior structure. Such manufacturers have experienced difficulty in strengthening the structure of such workpieces. In many situations, the hollow workpiece, such as the first rim portion 20 of FIG. 1 or workpiece 713 of FIG. 7, becomes misaligned with a fixture, upon which it is disposed. This potentially causes the stiffening material injected from a nozzle of an injection molding system to overflow or overfill. The nozzle may partially or entirely miss injecting stiffening material through a hole of the workpiece, causing the stiffening material to spill thereabout. Morever, some hollow bodies may have more or less volume than other hollow bodies, due to the injection molding system used. In such situations, potential underfill or overfill of the bodies may occur, rendering the resulting article unusable. Thus, we have improved the steps at blocks 402 and 504 of injecting or filling stiffening material into a hollow workpiece. We have also developed an improved method of filling a pre-formed hollow workpiece to add rigidity or stiffness to existing hollow workpieces.

42. As depicted in FIG. 6, the present invention includes method 610 of making a unitary composite article. Method 610 includes providing a one-piece, plastic body or workpiece including a collapsible first portion having an inner cavity defined by an outer wall formed by an injection molding process, wherein the body has a first hole in fluid communication with the inner cavity and wherein the plastic of the outer wall has a thickness which makes the outer wall susceptible to collapse into the inner cavity during normal usage of the body as shown in box 612. The method further includes locating the plastic body within a fixture such that the article is aligned within the fixture as shown in box 614. The fixture has interior surfaces to which the hollow workpiece may be in contact. The interior surfaces of the fixture complement the outside dimension of the workpiece to provide a sufficient fit thereto. The hollow body may be disposed or lowered to fit within the fixture. In the embodiment of FIGS. 1-3, the fixture is mold 15 on which the cooled resulting body 14 rests. In the embodiment of FIG. 7, workpiece 713 having first and second holes 717 and 718 and is disposed on fixture 712. However, any other shaped mold or support may be used as the fixture.

43. The method 610 further includes sensing a position of the first hole relative to the fixture, wherein the stiffening material is injected through the first hole. It is sensed by any suitable means whether the first hole is present and aligned to assure that the body is in alignment with the fixture. If it is sensed that the first hole is both present and aligned, then the injection molding system proceeds with filling stiffening material into the body in accordance with the present invention. However, if it is sensed that either the first hole is not present or not aligned, then a signal, preferably an audio signal, is activated to alert an operator of the system. The operation of method 610 is then stopped for adjustment, maintenance or repair to the body or fixture. Additionally, once it is sensed that the first hole is aligned, method 610 is carried on as provided below. The sensing above may be accomplished with a sensor to determine the position of the first hole. The sensor may be disposed on any suitable area, such as on the injection system or the fixture. In this embodiment, the sensor is a photoelectric sensor having a lense disposed adjacent the nozzle on the injection molding system. However, any other suitable sensor may be used.

44. As shown in box 616, method 610 further includes injecting a predetermined amount of flowable stiffening material into the first hole after the first hole is sensed to be present and aligned. The predetermined amount of stiffening material may vary depending on the volume contained in the body. In the embodiment shown in FIG. 3, the nozzle 54 of the injection molding system is lowered through the hole and substantially fills the inner cavity with stiffening material. In the embodiment provided in FIG. 7, the nozzle 715 also is disposed through hole 716 of body or workpiece 713 and fills a predetermined amount of stiffening material into the hollow workpiece. Upon completion, the injection molding system disengages from the workpiece, and the nozzle exits the hole.

45. Method 610 further includes sensing a fill condition or overfilling and underfilling of the stiffening material in the body. It is sensed whether the stiffening material has been overfilled and underfilled in the body. If it is sensed that the stiffening material has been overfilled or underfilled in the body, then method 610 is stopped to allow for removal of the stiffening material therefrom. If the body is sensed to be free of overfill and underfill, then method 610 is carried on by hardening the resulting frame structure as shown in box 505 of FIG. 5 and box 404 of FIG. 4, or by removing the workpiece from the fixture. This may be accomplished with a sensor disposed on the fixture or the injection molding system. In the embodiments shown in FIGS. 6-8, sensing overfill and underfill of the stiffening material in the body is accomplished with the sensor 718 being disposed on the injection molding system above the hole second 722. In this embodiment, the sensor may have a lens which determines the level of the stiffening material within the workpiece during injection of the stiffening material therein. The sensor is capable of determining the level of the stiffening material in the workpiece upon completion of the injection step in order to determine underfill or overfill therein. However, it is to be noted that sensing overfill and underfill of the stiffening material may be accomplished by any other suitable means.

46. FIGS. 7-8 depict system 710 making a unitary composite article. System 710 includes mold 712 upon which workpiece 713 having first and second holes 716, 722 and is disposed. Injection molding system 714 has nozzle 715 and sensors 717, 718 as shown. Nozzle 715 is insertable through hole 716 of body or workpiece 713 in order to fill workpiece 713 with stiffening material.

47. While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A unitary composite article comprising:
a one-piece, plastic body including a collapsible first portion having an inner cavity defined by an outer wall formed by an injection molding process, wherein the plastic of the outer wall has a thickness which makes the outer wall susceptible to collapse into the inner cavity during normal usage of the body; and
a stiffening material which substantially fills the inner cavity by an injection process, the stiffening material providing rigidity to the article to prevent collapse of the outer wall into the inner cavity when the plastic body experiences substantial external forces at the first portion during normal usage.

2. The article as claimed in claim 1 wherein the plastic body is produced by a gas-assisted injection molding process.

3. The article as claimed in claim 1 wherein the wall is elongated to form the plastic body.

4. The article as claimed in claim 1 wherein the article is a unitary composite steering wheel and air bag cover assembly.

5. The article as claimed in claim 2 wherein the plastic body further includes an air bag cover portion with a predetermined tear seam design formed therein, the air bag cover portion being adapted to overlie an inflatable air bag system and wherein the stiffening material includes a central support portion having a central aperture and adapted to be connected to the air bag system about the central aperture to allow an air bag of the air system to exit the air bag cover portion when deployed.

6. The article as claimed in claim 1 wherein the stiffening material is more rigid relative to the plastic of the body.

7. The article as claimed in claim 1 wherein the plastic of the body is softer relative to the stiffening material.

8. The article as claimed in claim 1 wherein the stiffening material is co-injected with the plastic of the body.

9. The article as claimed in claim 1 wherein the first portion is formed by a pressurized fluid to define a closed seamless interior surface which extends at least partially about the perimeter of the first portion.

10. The article as claimed in claim 1 wherein the stiffening material is one of high density polymer, glass-filled nylon, and epoxy.

11. The article as claimed in claim 1 wherein the plastic of the body is one of DYM, TPO, TPU, santoprene, low density polymer, and high density polymer.

12. A method of making a unitary composite article, the method comprising:
providing a one-piece, plastic body including a collapsible first portion having an inner cavity defined by an outer wall formed by an injection molding process, wherein the body has a first hole in fluid communication with the inner cavity and wherein the plastic of the outer wall has a thickness which makes the outer wall susceptible to collapse into the inner cavity during normal usage of the body; and
injecting a flowable stiffening material through the first hole and into the plastic body until the stiffening material substantially fills the inner cavity, to define the unitary composite article.

13. The method as claimed in claim 12 wherein the plastic body further includes a second hole formed therethrough.

14. The method as claimed in claim 13 further comprising sensing a position of the first hole prior to the step of injecting.

15. The method as claimed in claim 14 wherein injecting the stiffening material includes injecting the stiffening material through the first hole by an injection molding system.

16. The method as claimed in claim 13 further comprising sensing a fill condition based on a level of the stiffening material within the plastic body.

17. The method as claimed in claim 16 wherein sensing the fill condition includes sensing the level of stiffening material at the second hole.

18. The method as claimed in claim 12 wherein the stiffening material is one of high density polymer, glass-filled nylon, and epoxy.

19. The method as claimed in claim 12 wherein the article is a hollow steering wheel made by a gas assisted injection molding system.
